(19) United States
(12) Patent Application Publication
(10) Pub. No.: US 2014/0014792 A1
(43) Pub. Date: Jan. 16, 2014

(54) FASTENER ASSEMBLY FOR A GAS TURBINE

(71) Applicants: Christopher Paul Willis, Liberty, SC (US); Patrick Benedict Melton, Horse Shoe, NC (US); Lucas John Stoia, Taylors, SC (US); Richard Martin DiCintio, Simpsonville, SC (US); David William Cihlar, Greenville, SC (US)

(72) Inventors: Christopher Paul Willis, Liberty, SC (US); Patrick Benedict Melton, Horse Shoe, NC (US); Lucas John Stoia, Taylors, SC (US); Richard Martin DiCintio, Simpsonville, SC (US); David William Cihlar, Greenville, SC (US)

(73) Assignee: GENERAL ELECTRIC COMPANY, Schenectady, NY (US)

(21) Appl. No.: 13/548,263

(22) Filed: Jul. 13, 2012

(51) Int. Cl. F16B 21/00; F16M 13/02

(52) U.S. Cl. 248/200; 411/347

(57) ABSTRACT

A fastener assembly configured for use within an opening defined in a transition piece bracket is disclosed. The fastener assembly may generally include a fastener having a head configured to be positioned proximal to a first end of the opening and a body. The body may include a shank portion, a threaded portion opposite the shank portion and a recessed portion defined between the shank portion and the threaded portion. The fastener assembly may also include a retention member configured to be positioned within the opening adjacent the recessed portion such that the retention member engages at least one of the shank portion or the threaded portion as the fastener is moved within the opening. In addition, the fastener assembly may include a biasing member engaged against the retention member. The biasing member may be configured to bias the head of the fastener away from the first end of the opening.

### FIELD OF THE INVENTION

The present subject matter relates generally to fastener assemblies and, more particularly, to a fastener assembly for coupling a transition piece to a portion of a gas turbine.

### BACKGROUND OF THE INVENTION

In a gas turbine, hot gases of combustion flow from an annular array of combustors through a transition piece for flow along an annular hot gas path. Turbine stages are disposed along the hot gas path such that the hot gases of combustion flow from the transition piece through first-stage nozzles and buckets and through the nozzles and buckets of follow-on turbine stages. The first-stage nozzles typically include an annular array or assemblage of cast nozzle segments each containing one or more nozzle stator vanes per segment. Additionally, an annular retaining ring is typically positioned around the outer circumference of the first-stage nozzles and is configured to support the nozzles radially in the hot gas path of the turbine.

Current transition pieces are configured to be coupled to the retaining ring via a bracket bolted between the retaining ring and an aft frame of the transition piece. However, due to assembly space constraints, physical access to such bracket is typically limited. As a result, the bolts used to secure the bracket between the aft frame and the retaining ring must be inserted within the bracket prior to aligning each transition piece relative to the retaining ring. This can result in the bolts being knocked out and/or falling from the bracket as the transition piece is being installed. Moreover, because a portion of each bolt must extend outside the bracket to permit the bolt to be secured to the retaining ring, the bolts may be damaged (e.g., by rubbing against and/or contacting the retaining ring) during the installation process.

Accordingly, a fastener assembly that allows for a bolt or other fastener to be retained within the bracket and/or retracted within the bracket during installation and/or removal of a transition piece would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for coupling a transition piece within a gas turbine. The system may generally include a transition piece aft frame and a bracket coupled to the transition piece aft frame. The bracket may define an opening extending between a first end and a second end. In addition, the system may include a fastener having a head positioned proximal to the first end of the opening and a body extending at least partially within the opening. The body may include a shank portion, a threaded portion opposite the shank portion and a recessed portion defined between the shank portion and the threaded portion. The system may also include a retention member positioned within the opening adjacent the recessed portion. The retention member may be configured to engage at least one of the shank portion or the threaded portion as the fastener is moved within the opening. Moreover, the system may include a biasing member positioned within the opening. The biasing member may be configured to bias the head of the fastener away from the first end of the opening.

In another aspect, the present subject matter is directed to a fastener assembly configured for use within an opening defined in a transition piece bracket, wherein the opening extends between a first end and a second end. The fastener assembly may generally include a fastener having a head configured to be positioned proximal to the first end of the opening and a body configured to extend at least partially within the opening. The body may include a shank portion, a threaded portion opposite the shank portion and a recessed portion defined between the shank portion and the threaded portion. The fastener assembly may also include a retention member configured to be positioned within the opening adjacent the recessed portion such that the retention member engages at least one of the shank portion or the threaded portion as the fastener is moved within the opening. In addition, the fastener assembly may include a biasing member engaged against the retention member. The biasing member may be configured to bias the head of the fastener away from the first end of the opening.

In a further aspect, the present subject matter is directed to a fastener assembly configured for use within an opening defined in a component, wherein the opening extends between a first end and a second end. The fastener assembly may generally include a fastener movable within the opening between a retracted position and an attachment position. The fastener may include a body having a shank portion, a threaded portion opposite the shank portion and a recessed portion defined between the shank portion and the threaded portion. The fastener assembly may also include a retention member configured to be positioned within the opening adjacent the recessed portion such that the retention member engages at least one of the shank portion or the threaded portion as the fastener is moved between the retracted position and the attachment position. In addition, the fastener assembly may include a biasing member engaged against the retention member. The biasing member may be configured to bias the fastener towards the retracted position, wherein the threaded portion is at least partially refracted within the opening when the fastener is in the retracted position.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a partial, cross-sectional view of one embodiment of a gas turbine combustor;

FIG. 2 illustrates a partial, top view of the combustor shown in FIG. 1, particularly illustrating the interface between a transition piece of the combustor and a retaining ring of the gas turbine;

FIG. 3 illustrates an exploded view of one embodiment of a fastener assembly that may be utilized to couple a transition piece bracket to a retaining ring of a gas turbine;

FIG. 4 illustrates a side view of the fastener assembly shown in FIG. 3 in a retracted position;

FIG. 5 illustrates a side view of the fastener assembly shown in FIG. 3 in an attachment position; and

FIG. 6 illustrates a side view of an alternative configuration of the fastener assembly shown in FIGS. 3-5.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to a fastener assembly for coupling a transition piece within a gas turbine. Specifically, in several embodiments, the fastener assembly may include a fastener configured to be coupled between a bracket of the transition piece and another portion of the gas turbine, such as a retaining ring of the gas turbine. For example, the transition piece bracket may define an opening through which the fastener may be inserted and screwed into a corresponding opening defined in the retaining ring. Additionally, in one embodiment, the fastener assembly may include a retention member configured to retain the fastener within the bracket opening, thereby preventing the fastener from falling into the gas turbine as the transition piece is being installed and/or removed. For example, the retention member may be configured to engage portions of the fastener within the opening, thereby restricting the movement of the fastener relative to the bracket. Additionally, in several embodiments, the fastener assembly may include a biasing member configured to retract a portion of the fastener within the opening, thereby protecting the fastener from damage as the transition piece is being installed and/or removed.

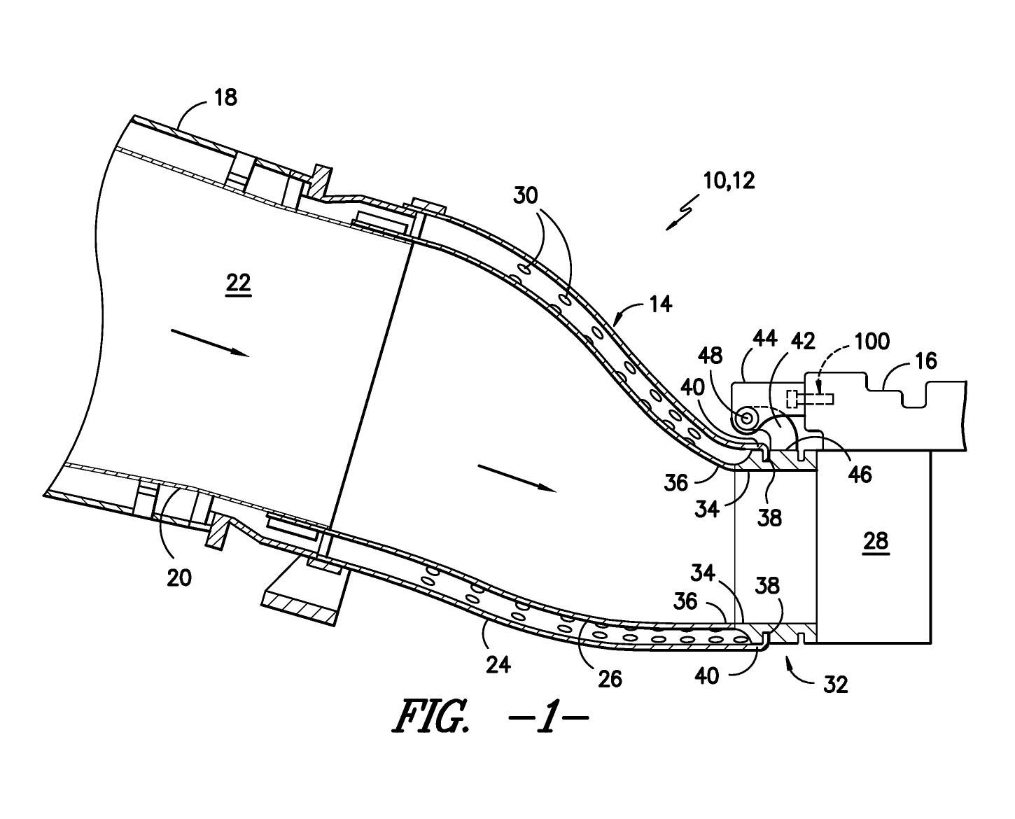

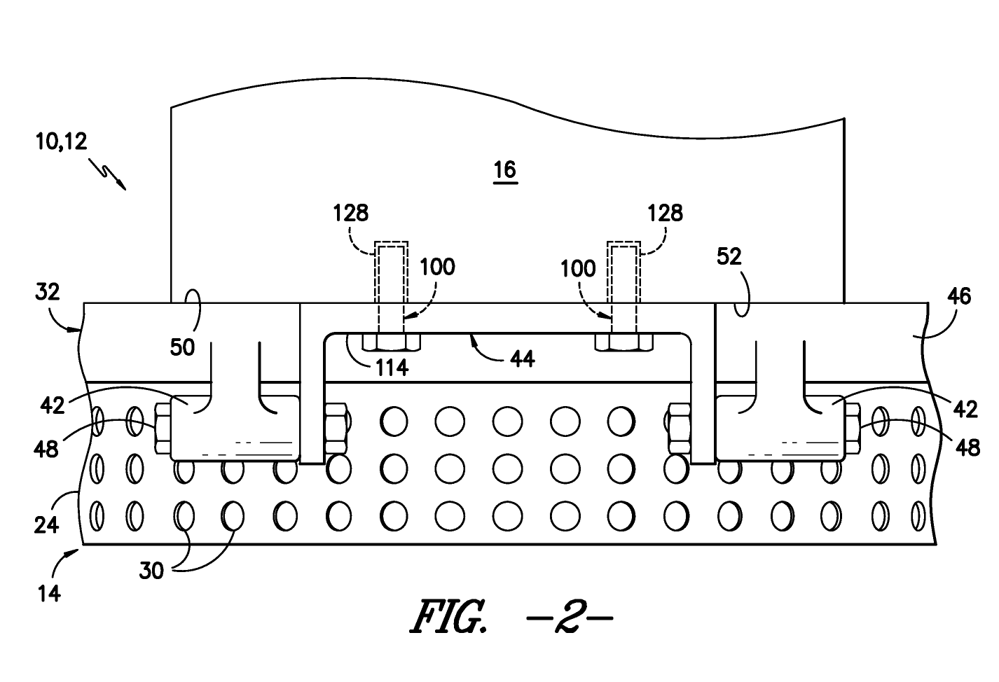

Referring now to the drawings, FIGS. 1 and 2 illustrate partial views of various components of a gas turbine 10. In particular, FIG. 1 illustrates a partial, cross-sectional view of a combustor 12 of a gas turbine 10. Additionally, FIG. 2 illustrates a partial, top view of the combustor 12 shown in FIG. 1, particularly illustrating the interface between a transition piece 14 of the combustor 12 and a retaining ring 16 of the gas turbine 10.

As shown, the combustor 12 may generally include an internal flow sleeve 18 and a combustion liner 20 substantially concentrically arranged within the flow sleeve 18. The combustion liner 20 may generally define a substantially cylindrical combustion chamber 22, wherein fuel and air are injected and combusted to produce hot gases of combustion. Additionally, both the flow sleeve 18 and the combustion liner 20 may extend, at their downstream ends, to a double walled transition piece 14, including an impingement sleeve 24 and an transition duct 26 disposed radially inwardly from the impingement sleeve 24. In particular, the combustion liner 20 may be coupled at its downstream end to the transition duct 26 such that the combustion liner 20 and the transition duct 26 generally define a flowpath for the hot gases of combustion flowing from the combustor 12 to a first stage nozzle 28 of the gas turbine 10. Moreover, the flow sleeve 18 may be coupled at its downstream end to the impingement sleeve 24 such that the flow sleeve 18 and the impingement sleeve 24 generally define a flowpath for the pressurized air discharged from a compressor (not shown) of the gas turbine 10. For example, the impingement sleeve 24 may define a plurality of cooling holes 30 configured to permit the pressurized air to enter the radial space defined between the transition duct 26 and the impingement sleeve 24. The pressurized air may then flow between the combustion liner 20 and the flow sleeve 18 to an end cap (not shown) of the combustor 12, wherein the air is mixed with fuel and injected into the combustion chamber 22.

As shown in FIGS. 1 and 2, the transition piece 14 may also include an aft frame 32 coupled to the downstream ends of the impingement sleeve 24 and the transition duct 24. In general, the aft frame 32 may be configured to be coupled to the impingement sleeve 24 and the transition duct 24 using any suitable attachment means and/or method known in the art. For example, as shown in FIG. 1, in one embodiment, the aft frame 32 may include a forward face 34 configured to be secured to the downstream end 36 of the transition duct 26, such as by welding the forward face 34 to the downstream end 36 of the transition duct 26. Similarly, as shown in FIG. 1, in one embodiment, the aft frame 32 may define a slot 38 configured to receive a downstream end 40 of the impingement sleeve 24, thereby coupling the aft frame 32 to the impingement sleeve 24.

Additionally, the aft frame 32 may be configured to be coupled to the annular retaining ring 16 of the gas turbine 10. In general, the aft frame 32 may be coupled to the retaining ring 16 using any suitable attachment means and/or method known in the art. For example, in several embodiments, the aft frame 32 may include suitable mounting structure, such as one or more support handles 42, configured to be coupled to the retaining ring 16 via a transition piece bracket 44. Specifically, as shown in FIGS. 1 and 2, the support handle(s) 42 may extend radially outwardly from an outer surface 46 of the aft frame 32 and may be configured to receive one or more suitable fasteners 48 (e.g., bolts, screws, pins and/or the like) for securing the transition piece bracket 44 to the aft frame 32.

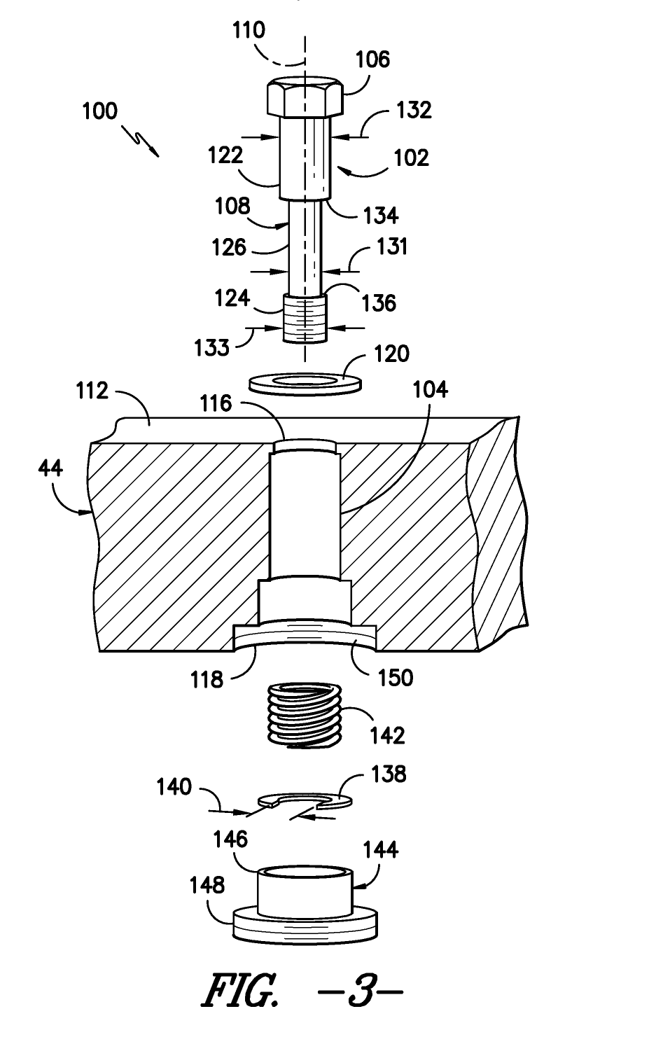

Moreover, as shown in the illustrated embodiment, the transition piece bracket 44 may be configured to extend axially from the support handle(s) 42 towards the retaining ring 16. For example, as particularly shown in FIG. 2, the transition piece bracket 44 may extend outwardly from the support handle(s) 42 such that an aft face 50 of the transition piece bracket 44 is positioned generally flush against a forward face 52 of the retaining ring 16. In addition, the transition piece bracket 44 may be configured to be secured to the retaining ring 16. For example, as will be described below with reference to FIGS. 3-6, the bracket 44 may be secured to the retaining ring 16 using one or more suitable fastener assemblies 100 configured to extend between the bracket 44 and the retaining ring 16.

It should be appreciated that the transition piece bracket 44 may generally define any suitable shape and/or have any suitable configuration that permits it to function as described herein. For example, as shown in FIG. 2, in one embodiment, the bracket 44 may generally define a C-shape. However, in other embodiments, the bracket 44 may have any other suitable shape and/or configuration that allows it to be coupled between the aft frame 32 and the retaining ring 16.

It should also be appreciated that, although the transition piece bracket 44 is generally described herein with respect to coupling the aft frame 32 to the retaining ring 16, the bracket 44 may generally be utilized to couple the aft frame 32 to any suitable component of the gas turbine 10. For example, the bracket 44 may be configured to be coupled between the aft frame 32 and a portion of the turbine casing (not shown) of the gas turbine 10 or between the aft frame 32 and any other suitable component of the gas turbine 10.

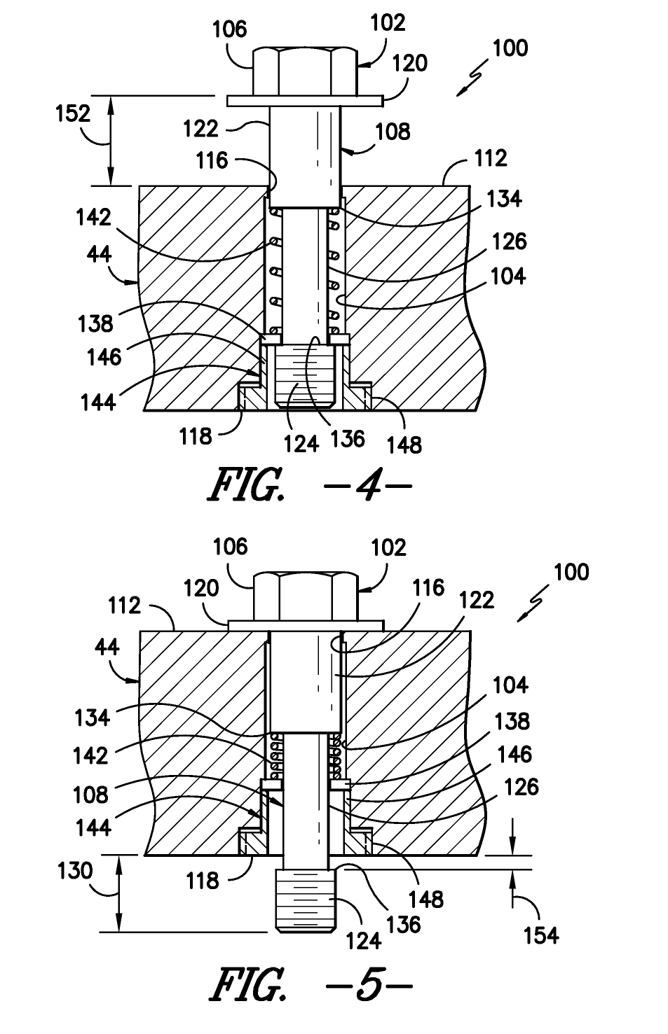

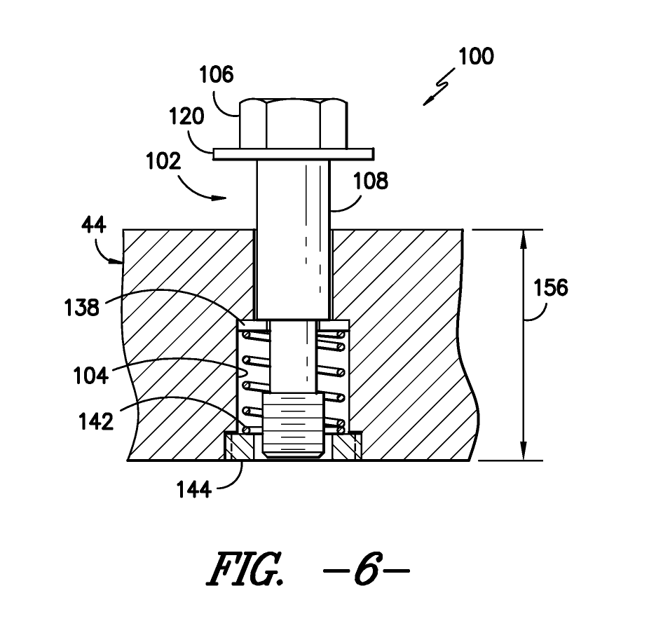

Referring now to FIGS. 3-5, one embodiment of a fastener assembly 100 that may be used to couple the transition piece bracket 44 to another component of the gas turbine 10 (e.g., the retaining ring 16) is illustrated in accordance with aspects of the present subject matter. In particular, FIG. 3 illustrates an exploded view of one embodiment of the fastener assembly 100. Additionally, FIGS. 4 and 5 illustrate side views of the fastener assembly 100 shown in FIG. 3, particularly illustrating the fastener assembly 100 in both a retracted position (FIG. 4) and an attachment position (FIG. 5).

As shown, the fastener assembly 100 may generally include a fastener 102 (e.g., a bolt or any other suitable mechanical fastener) configured to be received within an opening 104 defined in the transition piece bracket 44. In general, the fastener 102 may include a head 106 and a body 108 extending from the head 106 along a longitudinal axis 110 (FIG. 3) of the fastener 102. The head 106 of the fastener 102 may generally be configured to engage an outer surface 112 of the transition piece bracket 44 (e.g., a forward face 114 (FIG. 2) of the bracket 44) when the fastener 102 is fully inserted within the opening 104. For example, as shown in the illustrated embodiment, the opening 104 may extend between a first end 116 and a second end 118, with the fastener 102 being configured to be inserted within the first end of the opening 104. As such, when the fastener 102 is moved to the attachment position (FIG. 5), the head 106 may generally be engaged against the outer surface 112 defined at the first end 116 of the opening 104.

It should be appreciated that, in several embodiments, the head 106 of the fastener 102 may be configured to indirectly engage the outer surface 112 of the transition piece bracket 44. For example, as shown in the illustrated embodiment, a washer 120 may be installed on the fastener 102 such that the head 106 engages the outer surface 112 indirectly (via the washer 120) when the fastener 102 is moved to the attachment position. However, in other embodiments, the head 106 of the fastener 102 may be configured to directly engage the outer surface 112 of the transition piece bracket 44 (e.g., by removing the washer 120) when the fastener 102 is moved to the attachment position.

Additionally, as shown in the illustrated embodiment, the body 108 of the fastener 102 may generally include a shank portion 122 extending from the head 106, a threaded portion 124 opposite the shank portion 122 and a recessed portion 126 defined between the shank portion 122 and the threaded portion 124. In several embodiments, the threaded portion 124 may be configured to be secured within a corresponding threaded opening 128 (FIG. 2) defined in the retaining ring 16 (or any other component of the gas turbine 10), thereby permitting the transition piece bracket 44 to be coupled to the retaining ring 16 (or other gas turbine component) via the fastener 102. For example, as particularly shown in FIG. 5, when the fastener 102 is in the attachment position, the threaded portion 124 may extend outwardly from the second end 118 of the opening 104 a distance 130. As such, the threaded portion 124 may be screwed into the opening 128 defined in the retaining ring 16 (or other gas turbine component) in order to secure the bracket 44 to the retaining ring 16 (or other gas turbine component).

As shown in FIGS. 3-5, the body 108 of the fastener 102 may generally define a varying diameter or cross-sectional width 131, 132, 133 along its length. Specifically, in several embodiments, the recessed portion 126 may be configured to define a smaller cross-sectional width 131 than the cross-sectional widths 133, 133 of the shank portion 122 and the threaded portion 124. For example, as shown in the illustrated embodiment, the body 108 may have a stepped decrease in cross-sectional width as it transitions from the shank portion 122 to the recessed portion 126 and a stepped increase in cross-sectional width as it transitions from the recessed portion 126 to the threaded portion 124. As such, the body 108 may generally define a first flange 134 at the interface between the shank portion 122 and the recessed portion 126 and a second flange 136 at the interface between the recessed portion 126 and the threaded portion 124.

Moreover, as shown in the illustrated embodiment, the fastener assembly 100 may also include a retention member 138 configured to be positioned within the opening 104 at a location adjacent to the recessed position 126. Specifically, the retention member 138 may generally be configured to define an inner cross-sectional width 140 (FIG. 3) that is larger than the cross-sectional width 131 of the recessed portion 126 and smaller than the cross-sectional widths 132, 133 of the shank and threaded portions 122, 124. As such, by positioning the retention member 138 adjacent to the recessed portion 126, the retention member 138 may serve to restrict the movement of the fastener 102 relative to the bracket 44, thereby retaining the fastener 102 within the opening 104. For example, as shown in FIG. 4, as the head 106 of the fastener 102 is moved away from the first end 116 of the opening 104, the retention member 138 may prevent the fastener 102 from being removed from (and/or falling out of) the opening 104 by catching or otherwise engaging the second flange 136. Similarly, as shown in FIG. 5, depending on the length of the shank portion 122, the movement of the fastener 102 in the opposite direction (i.e., moving the head 106 towards the first end 116 of the opening 104) may be restricted by the head 106 engaging the outer surface 112 of the transition piece bracket 44 (either directly or indirectly via the washer 120) and/or the retention member 128 engaging the first flange 134 (either directly or indirectly through a biasing member 143). Accordingly, when the fastener assembly 100 is installed within the transition piece bracket 44, the fastener 102 may be fully retained within the opening 104.

It should be appreciated that the retention member 138 may generally comprise any suitable object and/or feature that is configured to function as described herein. For example, as particularly shown in FIG. 3, in one embodiment, the retention member 138 may comprise a C-washer configured to be installed on and/or around the recessed portion 126 of the body 108. However, in other embodiments, the retention member 138 may comprise any other suitable object that may be positioned within the opening 104 proximal to the recessed portion 138 so as to engage the first and/or second flange 134, 136 as the fastener 102 is moved relative to the bracket 44. Moreover, in a further embodiment, the retention member 138 may form part of the transition piece bracket 44. For example, the opening 104 may be defined in the transition piece bracket 44 so as to include a projection or flange that is configured to serve as the retention member 138.

Additionally, the fastener assembly 100 may also include a collar 144 configured to support the retention member 138 within the opening 104. Specifically, in several embodiments, the collar 144 may comprise a hollow, cylindrically-shaped body configured to be inserted and/or secured within the second end 118 of the opening 104. For instance, as shown in FIGS. 4 and 5, the collar 144 may be inserted/secured within the second end 118 of the opening 104 such that the retention member 138 is locked between a retention end 146 of the collar 144 and a portion of the transition piece bracket 44.

It should be appreciated that the collar 144 may be secured within the opening 104 using any suitable means known in the art. For example, as shown in the illustrated embodiment, the collar 144 may define a threaded end 148 configured to be secured within a corresponding threaded section 150 (FIG. 3) of the opening 104. Specifically, as shown in FIGS. 4 and 5, the threaded end 148 of the collar 144 may be configured to be screwed into the second end 118 of the opening 104 until the retention member 138 is engaged between the retaining end 146 of the collar 144 and a portion of the transition piece bracket 44. However, in other embodiments, the collar 144 may be secured within the opening 104 using any other suitable means known in the art, such as by welding the collar 144 within the opening 104 or by using any other suitable attachment means (e.g., by using retaining pins and/or any other suitable mechanical fasteners).

Referring particularly to FIGS. 4 and 5, the fastener assembly 100 may also include a biasing member 142 positioned within the opening 104. In general, the biasing member 142 may be configured to bias the threaded portion 124 of the fastener 102 in the direction of the first end 116 of the opening 104 (i.e., such that the head 106 of the fastener 102 is moved away from the first end 116 of the opening 104), thereby allowing the threaded portion 124 to be at least partially retracted within the opening 104. For example, as shown in the illustrated embodiment, the biasing member 142 may comprise a spring configured to be engaged between the retention member 138 and the first flange 134 of the fastener 102. Thus, when no opposing force is acting on the fastener 102, the force of the spring against the first flange 134 may cause the fastener 102 to move outwardly to the retracted position (i.e., such that a gap 152 (FIG. 4) is defined between the head 106 and the outer surface 112 of the transition piece bracket 44. Accordingly, by appropriately selecting the size and/or spring constant of the biasing member 142 and/or the lengths of the shank, recessed and threaded portions 122, 124, 126 of the fastener 102, the threaded portion 124 may be fully or partially retracted within the opening 104. As such, the threaded portion 124 may be protected from rubbing against or otherwise contacting the retaining ring 16 (or any other component of the gas turbine 10) as the transition piece 14 is being installed within the gas turbine 10. However, when it is desired to attach to the transition piece bracket 44 to the retaining ring 16 (or other gas turbine component), an opposing force may be applied against the fastener 102 (e.g., by pushing the head 106 of the fastener 102 towards the outer surface 112 of the transition piece bracket 44) to move the threaded portion 124 out from within the opening 104, thereby permitting the threaded portion 124 to be secured within the corresponding threaded opening 128 defined in the retaining ring 16 (or other gas turbine component).

It should be appreciated that, although the biasing member 142 is illustrated herein as being a spring, the biasing member 142 may generally comprise any suitable object that is capable of preforming the functions described herein. For example, in an alternative embodiment, the biasing member 142 may simply comprise a mass of elastic material capable of applying a suitable spring force against the fastener 102 in order to move the fastener 102 to the retracted position in the absence of opposing forces.

Additionally, it should be appreciated that, in several embodiments, the present subject matter may also be directed to a method for installing the fastener assembly 100 within the opening 104. Specifically, in one embodiment, the fastener 102 (optionally including the washer 120 installed thereon) may be initially inserted into the first end 116 of the opening 104 until the head 106 engages the outer surface 112 of the transition piece bracket 44. The biasing member 142 may then be installed on the fastener 102, such as by positioning the biasing 142 onto the threaded portion 124 and pushing the biasing member 142 into the opening 104 along the length of the body 108. The retention member 138 may then be installed on and/or around the recessed portion 126. For example, as shown in FIG. 5, when the fastener 102 is in the attachment position, a gap 154 may be defined between the transition piece bracket 44 and the threaded portion 124 that permits the retention member 138 to be installed on and/or around the recessed portion 126. The collar 144 may then be inserted into and/or secured within the second end 118 of the opening 104 in order to support the retention member 138 within the opening 104.

Referring now to FIG. 6, an alternative configuration of the fastener assembly 100 shown in FIGS. 3-5 is illustrated in accordance with aspects of the present subject matter. As shown, unlike the embodiment described above in which the biasing member 142 is engaged between the fastener 102 and the retention member 138, the biasing member 142 may be configured to be engaged between the retention member 138 and the collar 144. Such a configuration may allow for the size of the collar 144, as well as the thickness 156 of the transition piece bracket 44, to be reduced. Otherwise, the various components of the fastener assembly 100 may generally have the same configuration and perform the same function as those described above with reference to FIGS. 3-5.

It should be appreciated that, although the disclosed fastener assembly 100 has been described herein with reference to coupling a transition piece bracket 44 to a retaining ring 16 of a gas turbine 10, the fastener assembly 100 may generally be utilized to couple any two components together, particularly when it is desirable to retain the fastener 102 within an opening defined in one of the components and/or when it is desirable to retract a portion of the fastener 102 within the opening. Thus, it should be readily understood that the opening 104 described herein may generally be defined in any suitable component.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for coupling a transition piece within a gas turbine, the system comprising:
a transition piece aft frame;
a bracket coupled to the transition piece aft frame, the bracket defining an opening extending between a first end and a second end;
a fastener including a head positioned proximal to the first end of the opening and a body extending at least partially within the opening, the body including a shank portion, a threaded portion opposite the shank portion and a recessed portion defined between the shank portion and the threaded portion;
a retention member positioned within the opening adjacent the recessed portion, the retention member being configured to engage at least one of the shank portion or the threaded portion as the fastener is moved within the opening; and
a biasing member positioned within the opening, the biasing member configured to bias the head of the fastener away from the first end of the opening.

2. The system of claim 1, wherein a first flange is defined at the interface between the shank portion and the recessed portion and a second flange is defined at the interface between the recessed portion and the threaded portion.

3. The system of claim 2, wherein the retention member is configured to engage the second flange when the head of the fastener is moved away from the first end of the opening.

4. The system of claim 2, wherein the retention member is configured to engage the first flange when the head of the fastener is moved towards the first end of the opening.

5. The system of claim 2, wherein the biasing member is engaged between the retention member and the first flange.

6. The system of claim 1, wherein the biasing member is configured to bias the head of the fastener away from the first end of the opening such that the threaded portion is at least partially retracted within the opening when an opposing force is not applied to the fastener.

7. The system of claim 1, wherein the threaded portion is configured to extend outwardly from the second end of the opening when the head of the fastener is engaged against the bracket at the first end of the opening.

8. The system of claim 1, further comprising a collar extending at least partially within the opening between the retention member and the second end of the opening.

9. The system of claim 8, wherein the collar is configured to support the retention member within the opening.

10. The system of claim 8, wherein the biasing member is engaged between the retention member and the collar.

11. The system of claim 1, wherein the bracket is configured to be coupled between the transition piece aft frame and a retaining ring of the gas turbine.

12. A fastener assembly configured for use within an opening defined in a transition piece bracket, the opening extending between a first end and a second end, the fastener assembly comprising:
a fastener including a head configured to be positioned proximal to the first end of the opening and a body configured to extend at least partially within the opening, the body including a shank portion, a threaded portion opposite the shank portion and a recessed portion defined between the shank portion and the threaded portion;
a retention member configured to be positioned within the opening adjacent the recessed portion such that the retention member engages at least one of the shank portion or the threaded portion as the fastener is moved within the opening; and
a biasing member engaged against the retention member, the biasing member being configured to bias the head of the fastener away from the first end of the opening.

13. The fastener assembly of claim 12, wherein a first flange is defined at the interface between the shank portion and the recessed portion and a second flange is defined at the interface between the recessed portion and the threaded portion.

14. The fastener assembly of claim 13, wherein the retention member is configured to engage the second flange when the head of the fastener is moved away from the first end of the opening.

15. The fastener assembly of claim 13, wherein the retention member is configured to engage the first flange when the head of the fastener is moved towards the first end of the opening.

16. The fastener assembly of claim 13, wherein the biasing member is engaged between the retention member and the first flange.

17. The fastener assembly of claim 12, wherein the biasing member is configured to bias the head of the fastener away from the first end of the opening such that the threaded portion is at least partially retracted within the opening when an opposing force is not applied to the fastener.

18. The fastener assembly of claim 12, further comprising a collar extending at least partially within the opening between the retention member and the second end of the opening.

19. The fastener assembly of claim 18, wherein the biasing member is engaged between the retention member and the collar.

20. A fastener assembly configured for use within an opening defined in a component, the opening extending between a first end and a second end, the fastener assembly comprising:
a fastener movable within the opening between a retracted position and an attachment position, the fastener including a body having a shank portion, a threaded portion opposite the shank portion and a recessed portion defined between the shank portion and the threaded portion;
a retention member configured to be positioned within the opening adjacent the recessed portion such that the retention member engages at least one of the shank portion or the threaded portion as the fastener is moved between the retracted position and the attachment position; and
a biasing member engaged against the retention member, the biasing member being configured to bias the fastener towards the retracted position,
wherein the threaded portion is at least partially retracted within the opening when the fastener is in the retracted position.
